(19) United States
(12) Patent Application Publication
(10) Pub. No.: US 2026/0168859 A1
(43) Pub. Date: Jun. 18, 2026

(54) INFRARED (IR) SENSOR

(71) Applicant: TEXAS INSTRUMENTS INCORPORATED, Dallas, TX (US)

(72) Inventors: Jonathan Doylend, Savannah, MO (US); Yogesh Ramadass, San Jose, CA (US)

(21) Appl. No.: 19/388,879

(22) Filed: Nov. 13, 2025

Related U.S. Application Data
(60) Provisional application No. 63/733,581, filed on Dec. 13, 2024.

(51) Int. Cl. G01J 5/06; G01J 5/0806; G01J 5/0813; G01J 5/10

(52) U.S. Cl. CPC G01J 5/06; G01J 5/0806; G01J 5/0813; G01J 5/10

(57) ABSTRACT

A thermal sensing apparatus is described, which includes a thermal absorption layer, a first thermal sensor including at least a first portion in the thermal absorption layer, and a second thermal sensor including at least a second portion in the thermal absorption layer. The apparatus further includes a heat spreading layer in contact with an area of the thermal absorption layer, wherein a first lateral distance between the heat spreading layer and the first portion of the first thermal sensor is less than a second lateral distance between the heat spreading layer and the second portion of the second thermal sensor. The apparatus further includes a structure on or above a surface of the thermal absorption layer and configured to prevent thermal signals emitted by a target heat source from reaching the second thermal sensor.

### CROSS-REFERENCE TO RELATED APPLICATION

This application claims the benefit of and priority to U.S. Provisional Patent Application No. 63/733,581, filed Dec. 13, 2024, titled “Infrared (IR) Sensor,” which is incorporated herein by reference in its entirety.

### BACKGROUND

An infrared (IR) thermometer may include a sensor that estimates temperature of a target object by, for example, measuring an infrared radiation (also referred to as blackbody radiation or thermal radiation) from the target object because the intensity and/or spectrum of the IR radiation are closely related to the temperature of the target object. The infrared radiation includes electromagnetic waves ranging from, for example, about 0.7 micrometer (μm) to about 1000 μm. In one example, a human body may emit IR radiation with a peak emission wavelength between about 5 μm and about 10 μm (e.g., at about 9.5 μm) according to Planck's Law.

### SUMMARY

In some examples, an apparatus comprises: a thermal absorption layer; a first thermal sensor including at least a first portion in the thermal absorption layer; a second thermal sensor including at least a second portion in the thermal absorption layer; a heat spreading layer in contact with an area of the thermal absorption layer, wherein a first lateral distance between the heat spreading layer and the first portion of the first thermal sensor is less than a second lateral distance between the heat spreading layer and the second portion of the second thermal sensor; and a structure on or above a surface of the thermal absorption layer and configured to prevent thermal signals emitted by a target heat source from reaching the second thermal sensor.

In various embodiments, a packaged integrated circuit (IC) comprises: an enclosure defining a cavity; a die; a primary thermal sensor and a crosstalk thermal sensor on the die and coupled to the cavity; a thermal absorption layer, wherein at least a section of each of the primary thermal sensor and the crosstalk thermal sensor is in the thermal absorption layer; a first metal layer at least in part embedded within the thermal absorption layer, the first metal layer at least in part overlapping with the primary thermal sensor; and a second metal layer that is above the thermal absorption layer, the second metal layer at least in part overlapping with the crosstalk thermal sensor.

In various embodiments, an apparatus comprises: at least one primary thermal sensor and a plurality of crosstalk thermal sensors, wherein each of the plurality of crosstalk thermal sensors comprises a junction; a metal line in a form of a closed loop, the metal line in thermal contact with junctions of each of the plurality of crosstalk thermal sensors; a crosstalk estimation circuitry configured to estimate a crosstalk experienced by the apparatus, based at least in part on outputs of one or more of the plurality of crosstalk thermal sensors; and a signal estimation circuitry configured to estimate a parameter by measuring an output of the at least one primary thermal sensor, and reducing an effect of the crosstalk within the output of the at least one primary thermal sensor.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 is a diagram illustrating a sensing system, according to some examples.

FIG. 2 is a block diagram of a sensing system including a crosstalk estimation circuitry and a signal estimation circuitry, according to some examples.

FIG. 3 is a cross-sectional view of an example of a sensing system.

FIG. 4A is a plan view of a sensing system, according to some examples.

FIG. 4B is a cross-sectional view of a hot junction of a thermocouple of a primary sensor of the sensing system of FIG. 4A, according to some examples.

FIG. 5 is a temperature distribution map or heat map of a sensing system, according to some examples.

FIGS. 6A, 6B, 6C, and 6D are plan views of examples of sensing systems, according to some examples.

FIGS. 7A and 7B are cross-sectional and plan views of a sensing system, according to some examples.

FIG. 8 is a plan view of another sensing system, according to some examples.

FIG. 9 is a plan view of an array of thermal sensors, according to some examples.

FIGS. 10, 11, and 12 are cross-sectional views of examples of sensing systems, according to some examples.

FIGS. 13, 14, 15, 16, and 17 are cross-sectional views of examples of packaged devices comprising corresponding sensing systems, according to some examples.

### DETAILED DESCRIPTION

Disclosed herein is a sensing system configured to measure the temperature of a target object based on detected thermal signals, such as infrared (IR) radiation, emitted from the target object. The sensing system includes one or more crosstalk sensors to eliminate, or at least reduce, the influence of crosstalk or noise on the temperature measurement.

In one example, the sensing system comprises one or more primary sensors that detect IR signals emitted from the target object, where IR signals emitted from the target object are also referred to herein as target IR signals. However, during operation, the primary sensors may also receive undesired IR signals from components other than the target object, such as internal circuitry of the sensing system and/or other ambient objects. These undesired IR signals emitted by the non-target components may be referred to as crosstalk IR signals or simply crosstalk.

To reduce or eliminate the effect of such crosstalk on the temperature measurement of the target object, the sensing system further includes one or more sensors (referred to herein as crosstalk sensors or auxiliary sensors) configured to detect crosstalk IR signals from the non-target components but not IR signals from the target object. The sensing system can then estimate and subtract the contribution of the crosstalk IR signals from measurements output by the primary sensors, thereby improving the accuracy of the temperature measurement of the target object.

In some examples, the sensing system comprises a thermal absorption layer and a heat spreading layer at least in part overlapping with the primary sensors. The thermal absorption layer may absorb IR signals incident on the thermal absorption layer, and the heat spreading layer may spread the thermal energy from the absorbed IR signals to regions in the vicinity of the primary sensors, e.g., to improve measurements of the target IR signals by the primary sensors. In an example, the heat spreading layer may be spaced sufficiently apart from the crosstalk sensors, such that the crosstalk sensors are not affected by the thermal energy of the absorbed target IR signals. In an example, to at least in part maintain similar operating and detection conditions between the primary sensors and the crosstalk sensors, the thermal absorption layer may also overlap with the crosstalk sensors.

In some examples, to ensure that the crosstalk sensors measure primarily the crosstalk IR signals (and not the target IR signals), the sensing system comprises a structure configured to prevent thermal signals emitted by the target object from reaching the crosstalk sensors. In one example, the structure may be in the form of a reflective layer (such as a reflective metal layer or a thermal shield) configured to shield the crosstalk sensors from the target IR signals. The reflective layer may be above a portion of the thermal absorption layer that overlaps with the crosstalk sensors. In another example, the structure may be in the form of a lens or another optical arrangement (such as a diffractive optical element or a prism) to direct the target IR signals towards the primary sensors and away from the crosstalk sensors. Numerous configurations and examples of the sensing system are described below in further detail.

Here, the same reference numbers or other reference designators are used in the drawings to designate the same or similar (either by function and/or structure) features.

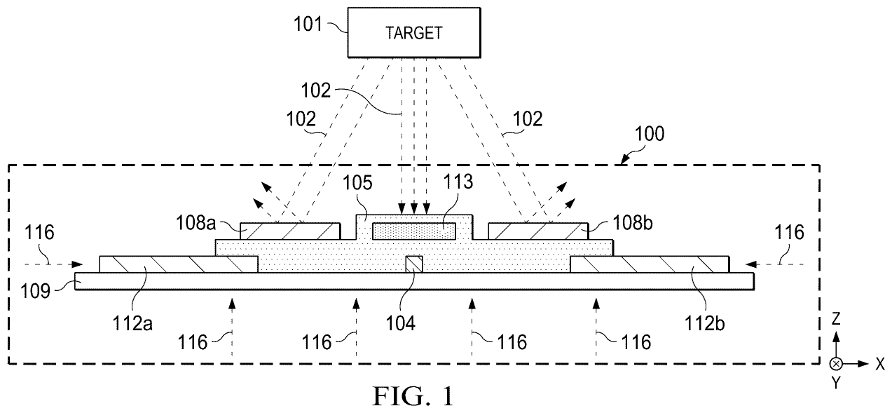

FIG. 1 is a diagram illustrating a sensing system 100, according to some examples. Sensing system 100 is configurable to measure temperature of target objects, such as an example of a target 101 illustrated in FIG. 1. Target 101 can be a target heat source to be measured by sensing system 100. Sensing system 100 comprises one or more primary sensors 104 and one or more crosstalk sensors 112. Crosstalk sensors 112 are configurable to estimate a thermal crosstalk experienced by primary sensors 104 of sensing system 100. The estimated thermal crosstalk may be then used to improve the temperature measurement of target 101, as described below in further detail.

Sensing system 100 includes one or more primary sensors 104 (also referred to as primary thermal sensors) on a die 109. Although a single primary sensor 104 is illustrated in FIG. 1, sensing system 100 may comprise a plurality of primary sensors 104, as described below in further detail. Primary sensor 104 senses thermal signals, such as infrared light signals emitted by heat emitting sources, and provides an output representing, for example, an amount (e.g., an intensity) of the sensed IR light signals. Primary sensor 104 is a thermal sensor, such as a non-contact thermal sensor (e.g., comprising thermocouples, infrared photodetectors, and/or one or more other non-contact thermal sensors).

Primary sensor 104 receives thermal signals, such as IR signals 102, from target 101. IR signals 102 are target IR signals that can indicate the temperature of target 101. In an example, primary sensor 104 may also receive thermal signals, such as IR signals 116 (illustrated using dashed lines in FIG. 1) from one or more other sources, e.g., from non-target components within and/or outside sensing system 100. IR signals 116 represent crosstalk and may also be referred to as crosstalk IR signals from thermal sources other than target 101. Thus, the output of primary sensor 104 is affected not only by IR signals 102 received from target 101 but also by IR signals 116 received from components other than target 101. Because primary sensor 104 receives both IR signals 102 and IR signals 116, output of primary sensor 104 may be representative of thermal energy of not only target 101, but also sources of IR signals 116.

In some examples, to eliminate or at least reduce the effects of IR signals 116 on the temperature sensed by primary sensor 104, sensing system 100 comprises a plurality of crosstalk sensors 112 (also referred to as crosstalk thermal sensors). Crosstalk sensors 112 primarily receive IR signals 116 and may not receive (or receive only a small portion) of IR signals 102 from target 101. Accordingly, the output of crosstalk sensors 112 may primarily be representative of IR signals 116 and may not be substantially affected by IR signals 102. On the other hand, primary sensor 104 receives both IR signals 116 and IR signals 102. Accordingly, based on the output of crosstalk sensors 112, a processing circuit (not shown in FIG. 1) of sensing system 100 can eliminate or at least reduce effects of IR signals 116 on temperature sensed by primary sensor 104. Accordingly, the final temperature output of sensing system 100 may primarily be representative of IR signals 102 from target 101 and not substantially affected by crosstalk IR signals 116.

In an example, sensing system 100 comprises a die 109. Primary sensor 104 and/or crosstalk sensors 112 may be part of die 109, or mounted on die 109 either directly or through one or more intermediate layers. In the example of FIG. 1, primary sensor 104 and crosstalk sensors 112 are illustrated to be formed on die 109. In an example, die 109 comprises one or more processing circuits (described below in further detail) configurable to process outputs from various sensors.

In an example, sensing system 100 comprises a thermal absorption layer 105. Thermal absorption layer 105 is formed on die 109 and at least in part embeds primary sensor 104 and/or crosstalk sensors 112. For example, at least a portion of primary sensor 104 is in thermal absorption layer 105, and at least a portion of each of crosstalk sensors 112 is in thermal absorption layer 105. In an example, thermal absorption layer 105 is above and in thermal contact with primary sensor 104 and/or crosstalk sensors 112.

In an example, thermal absorption layer 105 has relatively high infrared light absorption at the wavelengths of interest (e.g., middle-wavelength IR (MWIR) to long-wavelength IR (LWIR) light) compared to one or more other layers of sensing system 100, such as reflector layers 108a and 108b, and a heat spreading layer 113 described below. Thus, thermal absorption layer 105 converts incident infrared light to thermal energy, which may be selectively transferred to thermal sensors by, for example, heat spreading layer 113, as described below in further detail. Example materials of thermal absorption layer 105 for incident IR light with wavelengths between about 5 μm and about 10 μm comprise glass or another oxide, an organic material (e.g., a polymer), and/or a doped semiconductor material (such as silicon, doped with an appropriate carrier with relatively high concentration such that the doped semiconductor material acts as a thermal absorption layer).

In an example, heat spreading layer 113 is in contact with (e.g., embedded in) an area of thermal absorption layer 105. In an example, heat spreading layer 113 at least in part overlaps with primary sensor 104 such that at least a section of heat spreading layer 113 is vertically above (or below) primary sensor 104. In the example of FIG. 1, at least a section of heat spreading layer 113 is vertically above primary sensor 104. Some examples described below have at least a section of heat spreading layer 113 vertically below primary sensor 104.

In an example, heat spreading layer 113 is proximal to primary sensor 104 rather than to crosstalk sensors 112. For example, a first lateral distance (e.g., in a plan view) between heat spreading layer 113 and a portion of primary sensor 104 (e.g., which is in thermal absorption layer 105) is less than a second lateral distance between heat spreading layer 113 and a portion of each of crosstalk sensors 112 that is in thermal absorption layer 105. In an example, heat spreading layer 113 does not overlap with crosstalk sensors 112. For example, no part of heat spreading layer 113 is vertically above or below crosstalk sensors 112. In an example, heat spreading layer 113 is at least in part embedded within thermal absorption layer 105. In an example, heat spreading layer 113 may be a heat reflective metal layer comprising a metal or metal alloy material, such as aluminum, copper, gold, or another metal or metal alloy material that reflects IR signals.

In an example, sensing system 100 further comprises one or more reflector layers 108. For example, in FIG. 1, a plurality of crosstalk sensors 112 (e.g., including crosstalk sensors 112a and 112b) and a corresponding plurality of reflector layers 108 (e.g., including reflector layers 108a and 108b) are illustrated. In an example, reflector layers 108 comprise metal, metal alloy, or another material that can reflect thermal energy (e.g., IR signals), such as aluminum, copper, gold, or another metal. In some examples, each reflector layer 108 may include a reflective IR coating, a reflective grating, or a reflective metalens.

In an example, a reflector layer 108 at least in part overlaps with a corresponding crosstalk sensor 112. For example, reflector layer 108a is at least in part above and at least in part overlaps with corresponding crosstalk sensor 112a, and reflector layer 108b is at least in part above and at least in part overlaps with corresponding crosstalk sensor 112b.

In an example, target IR signals 102 from target 101 are incident on reflector layers 108a and 108b, and on thermal absorption layer 105. Because reflector layers 108a and 108b act as reflectors for IR signals, IR signals 102 incident on reflector layers 108a and 108b are reflected by reflector layers 108a and 108b. Accordingly, IR signals 102 may not reach portions of thermal absorption layer 105 that are above crosstalk sensors 112. Reflector layers 108a and 108b act as shields for IR signals 102, preventing or at least reducing chances of IR signals 102 reaching portions of thermal absorption layer 105 that are above crosstalk sensors 112. Hence, portions of thermal absorption layer 105 that are above crosstalk sensors 112 are not heated by IR signals 102 and measurements of crosstalk sensors 112 are not affected by IR signals 102.

On the other hand, IR signals 102 can reach a portion of thermal absorption layer 105 that is not shielded by reflector layers 108. Accordingly, thermal absorption layer 105 above or in the vicinity of primary sensor 104 absorbs heat energy in IR signals 102 from target 101. The absorbed heat energy from target 101 may be transferred to heat spreading layer 113. IR signals 102 that have not been absorbed by thermal absorption layer 105 may be incident on and be reflected off heat spreading layer 113, and the reflected IR signal may be absorbed by the portion of thermal absorption layer 105 above heat spreading layer 113. Therefore, there is a “double pass” absorption of IR signals 102 from target 101 by portion of thermal absorption layer 105 above heat spreading layer 113—(i) during a first pass, direct absorption of IR signals from target 101, and (ii) during a second pass, absorption of IR signals reflected by heat spreading layer 113. Thus, heat spreading layer 113 facilitates transferring heat from target 101 to thermal absorption layer 105 and eventually to primary sensor 104.

In at least one example, primary sensor 104 and crosstalk sensors 112 are spaced sufficiently apart from each other such that the heating of the portion of thermal absorption layer 105 in the vicinity of primary sensor 104 (e.g., due to IR signals 102) may not contribute to heating of crosstalk sensors 112. In an example, the output of crosstalk sensors 112 may not be affected by target IR signals 102 from target 101, whereas the output of primary sensor 104 may indicate the thermal energy of target IR signals 102 from (and thus the temperature of) target 101 (e.g., output of primary sensor may be primarily affected by target IR signals 102 from target 101). For example, both primary sensor 104 and crosstalk sensors 112 receive crosstalk IR signals 116 from components of sensing system 100 and/or from one or more components (such as ambient heat) other than target 101. The output of primary sensor 104 may be a measure of both target IR signals 102 and crosstalk IR signals 116, whereas output of crosstalk sensors 112 may be a measure of primarily crosstalk IR signals 116.

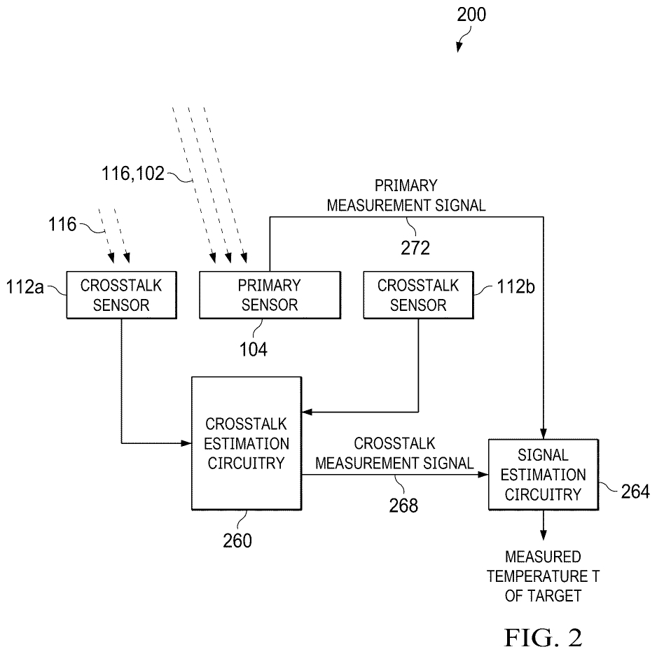

FIG. 2 is a block diagram of a sensing system 200 including a crosstalk estimation circuitry 260 and a signal estimation circuitry 264, according to some examples. Sensing system 200 may be included within any of the sensing systems or packaged devices described herein, such as sensing system 100. In an example, crosstalk estimation circuitry 260 receives outputs of one or more crosstalk sensors 112 (such as from crosstalk sensors 112a and 112b) and generates a crosstalk measurement signal 268 that is primarily affected by crosstalk IR signals 116. For instance, the output of crosstalk sensors 112 may be a measure of IR signals 116.

In one example, crosstalk estimation circuitry 260 may average outputs of a plurality of crosstalk sensors 112 to generate crosstalk measurement signal 268. In another example, crosstalk estimation circuitry 260 may consider directionality of outputs of a plurality of crosstalk sensors 112, e.g., in cases where different crosstalk sensors provide different levels of output, owing to crosstalk IR signals being emitted from one particular area or direction of sensing system 100.

In at least one example, primary sensor 104 may output a primary measurement signal 272 that is representative of IR signals 116 and IR signals 102 (e.g., the output of primary sensor 104 may be a measure of both target IR signals 102 and crosstalk IR signals 116). In an example, crosstalk measurement signal 268 and primary measurement signal 272 may be represented as follows:

Crosstalk measurement signal=a1*target IR signals+b1*crosstalk IR signals. Equation 1

Primary measurement signal=c1*target IR signals+d1*crosstalk IR signals. Equation 2

In Equations 1 and 2, coefficients a1, b1, c1, and d1 are representative factors affecting measurements of the various signals by the various sensors. In an example, as crosstalk measurement signal 268 output by crosstalk estimation circuitry 260 may primarily be affected by IR signals 116 (and not by IR signals 102) and so coefficient a1 may be low (e.g., lower than coefficient b1). In an ideal case (e.g., where reflector layers 108 fully prevent target IR signals 102 from reaching crosstalk sensors 112), coefficient a1 may be equal to or close to zero.

Also, as IR signals 116 may substantially equally affect primary sensor 104 and crosstalk sensors 112, coefficients b1 and d1 may be close to each other, and/or may be equal in an example. Assuming coefficients b1 and d1 are equal, from equations 1 and 2, IR signals 102 may be estimated as follows:

Target IR signals=(Primary measurement signal−Crosstalk measurement signal)/(c1−a1). Equation 3

Coefficient or weights a1 and c1 may be estimated during a calibration phase of sensing system 100. For example, one or more known temperatures of one or more objects may be measured by sensing system 100, and such measurements may be used to estimate weights a1 and c1. In some examples, coefficients b1 and d1 may not be the same due to, for example, the differences between the sensitivities (e.g., caused the different structures and/or different environmental conditions) of primary sensor 104 and crosstalk sensors 112, and may be determined during calibration (e.g., by fully blocking target IR signals during some calibration measurements, or by assuming a1=0 when reflector layers 108 are appropriately designed and manufactured to provide proper shielding).

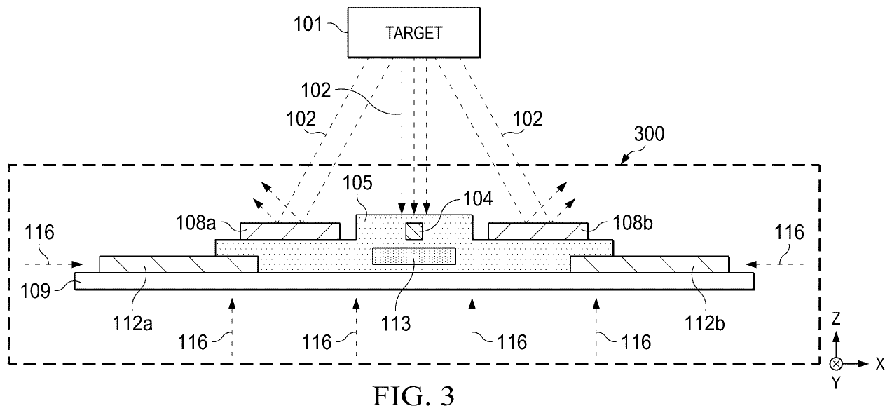

FIG. 3 is a cross-sectional view of an example of a sensing system 300, according to some examples. In sensing system 100 of FIG. 1, primary sensor 104 is under heat spreading layer 113, while in sensing system 300 of FIG. 3 heat spreading layer 113 is under primary sensor 104. In an example, although heat spreading layer 113 is under primary sensor 104 in sensing system 300, heat spreading layer 113 facilitates spreading of heat throughout the portion of thermal absorption layer 105 in the vicinity of primary sensor 104, thereby facilitating sensing of IR signals 102 from target 101. In an example, primary sensor 104 and one or more crosstalk sensors 112 may be at different levels or planes within thermal absorption layer 105, as illustrated in FIG. 3. In one such example, primary sensor 104 and one or more crosstalk sensors 112 may be on the same layer (e.g., see FIG. 1) or different layers (e.g., see FIG. 3) in the thermal absorption layer. In some examples, crosstalk sensors 112 may be formed in one or more layers above heat spreading layer 113. In some examples, crosstalk sensors 112 may be formed in one or more layers below heat spreading layer 113. In some examples, crosstalk sensors 112 may be formed in one or more layers below heat spreading layer 113 and one or more layers above heat spreading layer 113.

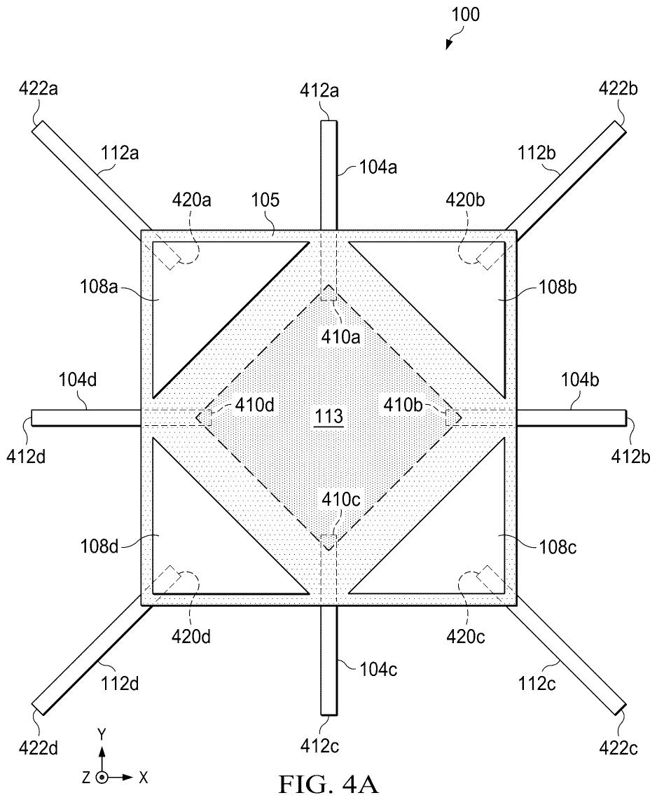

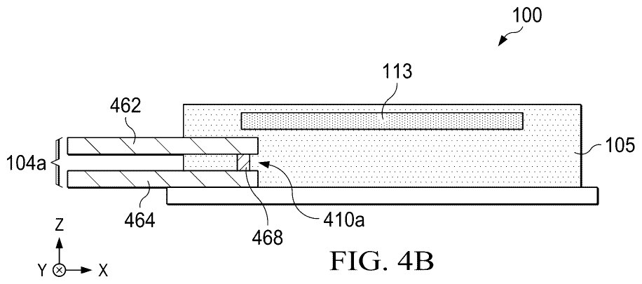

FIG. 4A is a plan view of sensing system 100 illustrated in FIG. 1, according to some examples. In the illustrated example, heat spreading layer 113 is buried within thermal absorption layer 105. Accordingly, in the plan view of FIG. 4A, heat spreading layer 113 may not be visible and hence is illustrated using dotted lines. In the example of FIG. 4A, heat spreading layer 113 has a rectangular shape. However, other example shapes of heat spreading layer 113 may also be possible, as described below in further detail.

In the example of FIG. 4A, sensing system 100 comprises four primary sensors 104a, 104b, 104c, and 104d, although sensing system 100 may include another appropriate number of such primary sensors (such as two, six, or eight). In an example, each such primary sensor 104 comprises a thermal sensing element, such as a thermocouple. Thus, primary sensor 104 comprises a plurality of such thermal sensing elements. In an example, plurality of primary sensors 104a, 104b, 104c, and 104d may be coupled to form a thermopile. A thermocouple is a temperature sensor comprising two dissimilar metals joined at one end. A thermocouple comprises a hot junction (e.g., thermal sensing junction) and a cold junction. When the hot junction is exposed to heat, the hot junction produces a voltage that is proportional to a temperature difference between the hot junction and the cold junction, where the cold junction acts as a reference junction and may be coupled to a thermal reference (e.g., thermal ground).

In an example, primary sensors 104a, 104b, 104c, and 104d comprise hot junctions 410a, 410b, 410c, and 410d, respectively, and cold junctions 412a, 412b, 412c, and 412d, respectively. Hot junctions 410a, 410b, 410c, and 410d may be thermally coupled together by heat spreading layer 113 in proximity to the hot junctions, and cold junctions 412a, 412b, 412c, and 412d may be thermally coupled to a common thermal reference (e.g., thermal ground). In an example, cold junctions 412a, 412b, 412c, and 412d of primary sensors 104a, 104b, 104c, and 104d, respectively, may be spaced sufficiently apart from the corresponding hot junctions, heat spreading layer 113 and/or thermal absorption layer 105, such that IR signals 102 from target 101 do not reach cold junctions 412a, 412b, 412c, and 412d. In an example, cold junctions 412a, 412b, 412c, 412d may be outside thermal absorption layer 105 such that thermal absorption layer 105 may not overlap with cold junctions 412a, 412b, 412c, and 412d.

As illustrated in FIGS. 1 and 3, primary sensors 104 and heat spreading layer 113 have a vertical separation where at least a section (e.g., the hot junction) of each of primary sensors 104 may be under heat spreading layer 113 (see FIG. 1) or above heat spreading layer 113 (see FIG. 3). Portions of each of primary sensors 104a, 104b, 104c, and 104d may be within thermal absorption layer 105. In at least one example, the portions of each of primary sensors 104a, 104b, 104c, and 104d, which may be within thermal absorption layer 105 and under or above heat spreading layer 113, are illustrated using dotted lines in FIG. 4A.

In an example, heat spreading layer 113 has a rectangular or square shape and has corners or vertices. Each of hot junctions 410a, 410b, 410c, and 410d may be adjacent to or partially overlap with a respective vertex of the plurality of vertices of heat spreading layer 113.

In an example, four crosstalk sensors 112a, 112b, 112c, and 112d are at four corners (e.g., vertices) or peripheral regions of thermal absorption layer 105. Although four crosstalk sensors on four corners are illustrated, the number and/or locations of the crosstalk sensors may vary from one example to another. In an example, each of crosstalk sensors 112a, 112b, 112c, and 112d comprises a thermocouple. In an example, plurality of crosstalk sensors 112a, 112b, 112c, and 112d may be coupled together to form a thermopile.

Crosstalk sensors 112a, 112b, 112c, and 112d comprise hot junctions 420a, 420b, 420c, and 420d, respectively and cold junctions 422a, 422b, 422c, and 422d, respectively. In some examples, hot junctions 420a, 420b, 420c, and 420d may be thermally coupled together by a thermal conductor (not shown in FIG. 4A) in proximity to the hot junctions, while cold junctions 422a, 422b, 422c, and 422d may be thermally coupled to the common thermal reference (e.g., thermal ground) that cold junctions 412a, 412b, 412c, and 412d are thermally coupled to. In an example, cold junctions 422a, 422b, 422c, and 422d may be spaced sufficiently apart from the corresponding hot junctions and may not overlap with thermal absorption layer 105 and/or reflector layers 108, as illustrated in FIG. 4A.

In an example, a portion of crosstalk sensors 112a, 112b, 112c, and 112d, including corresponding hot junctions 420a, 420b, 420c, and 420d, may be in thermal absorption layer 105 and under reflector layers 108a, 108b, 108c, and 108d, respectively. Accordingly, such portions of crosstalk sensors 112a, 112b, 112c, and 112d may not be visible in the plan view of FIG. 4A and are illustrated using dotted lines.

In an example, a portion of each of crosstalk sensors 112a, 112b, 112c, and 112d including corresponding hot junction 420a, 420b, 420c, or 420d may be at a lateral distance greater than a threshold value (e.g., a threshold lateral distance) away from heat spreading layer 113. Such a minimum threshold distance between hot junctions 420a, 420b, 420c, and 420d and heat spreading layer 113 may ensure that hot junctions 420a, 420b, 420c, and 420d of crosstalk sensors are not affected by heat spread by heat spreading layer 113.

FIG. 4B is a cross-sectional view of a portion of sensing system 100 that includes a hot junction (e.g., hot junction 410a) of a thermocouple of a primary sensor (e.g., primary sensor104a), according to some examples. As described above with respect to FIG. 4A, hot junction 410a may be embedded within thermal absorption layer 105 and may be below (e.g., as illustrated in FIG. 1) or above (e.g., as illustrated in FIG. 3) heat spreading layer 113. In an example, a thermocouple comprises two dissimilar materials that are joined together to form a hot junction, where a temperature difference between the hot junction and a cold junction at a thermal reference induces a voltage. This voltage is proportional to the temperature gradient between the hot junction and the cold junction, enabling temperature measurement or thermal-to-electrical energy conversion. The voltage can be measured at distal ends of the two dissimilar materials (e.g., between cold junctions at the thermal reference). In the example illustrated in FIG. 4B, a thermocouple of primary sensor 104a comprises an upper layer 462 and a lower layer 464. In an example, upper layer 462 comprises titanium nitride (TiN) and lower layer 464 comprises polysilicon, although other materials may also be used. Upper layer 462 and lower layer 464 form a thermoelectric junction that generates a voltage in response to a temperature difference between the hot and cold junctions. The region labeled 468 represents an electrical and thermal contact area or joint, where upper layer 462 and lower layer 464 are physically and electrically joined. In another example, the thermocouple may be formed by a single material, e.g. polysilicon, where a voltage may be generated along the length of the single material of the thermocouple in response to a thermal gradient along the length.

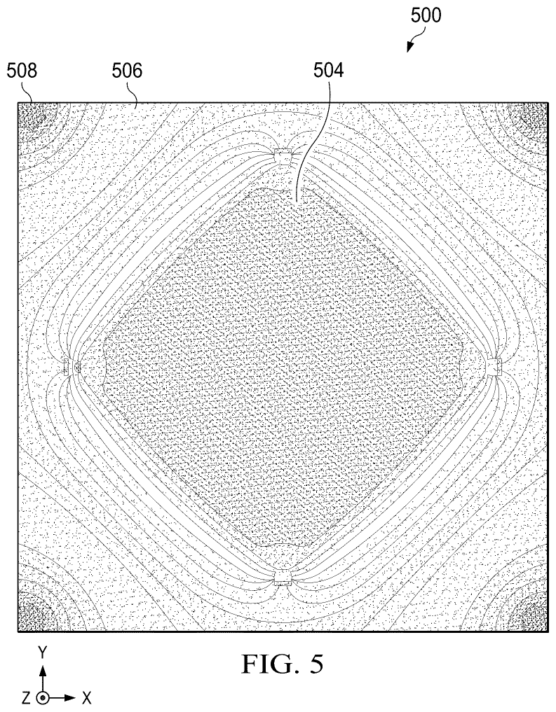

FIG. 5 is a temperature distribution map or heat map 500 of a sensing system (such as sensing system 100 or another sensing system described herein), according to some examples. Referring to the plan view of sensing system 100 in FIG. 4A and heat map 500, the temperature across sensing system 100 reduces from a center having relatively high temperature region 504 to four corners or vertices having low temperature regions 508. High temperature region 504 may a region where heat spreading layer 113 is located, while low temperature regions 508 may be regions where crosstalk sensors 112 are located. An intermediate temperature region 506 is also illustrated between high temperature region 504 and low temperature regions 508. There are various other temperature gradients that are unlabeled in FIG. 5, but the temperature gradually decreases from high temperature region 504 towards low temperature regions 508.

Temperature at high temperature region 504 is relatively high (e.g., compared to intermediate temperature region 506 and low temperature regions 508), due to effects of heat spreading layer 113 embedded within thermal absorption layer 105. In an example, high temperature region 504 roughly correspond to the footprint of heat spreading layer 113.

As illustrated in FIG. 5, four corners of sensing system 100 correspond to low temperature regions 508 due to (i) absence of heat spreading layer 113 at or near low temperature regions 508 and/or (ii) shielding or reflective effects of reflector layers 108a, 108b, 108c, and 108d. The four corners of sensing system 100 may not be substantially affected by target IR signals 102. Accordingly, hot junctions 420a, 420b, 420c, and 420d of crosstalk sensors 112a, 112b, 112c, and 112d are placed within these low temperature regions 508. Hence, crosstalk sensors 112a, 112b, 112c, and 112d sense crosstalk IR signals 116, and not target IR signals 102 from target 101.

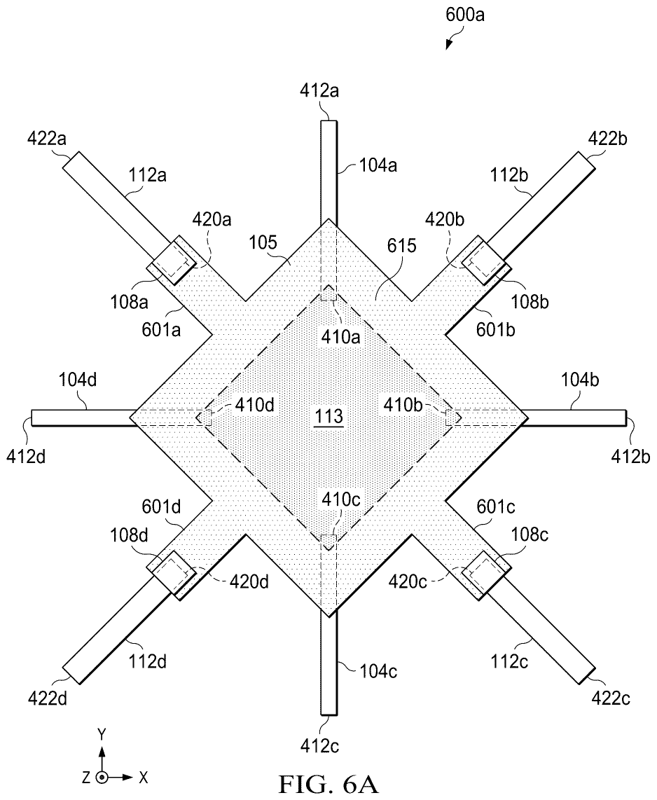

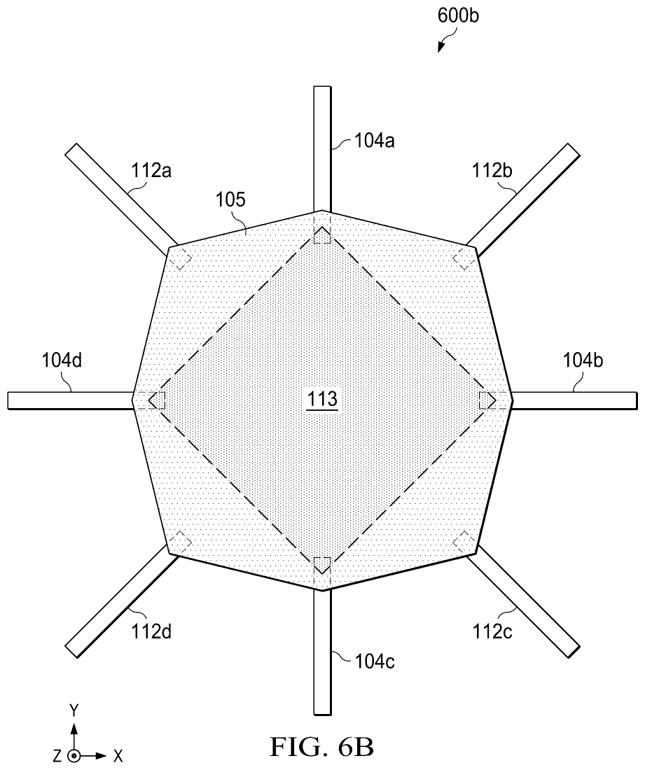

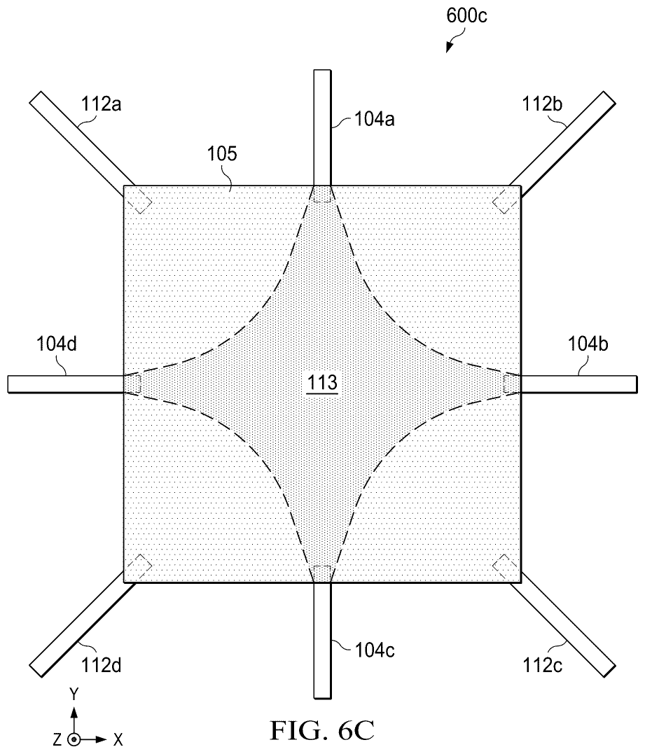

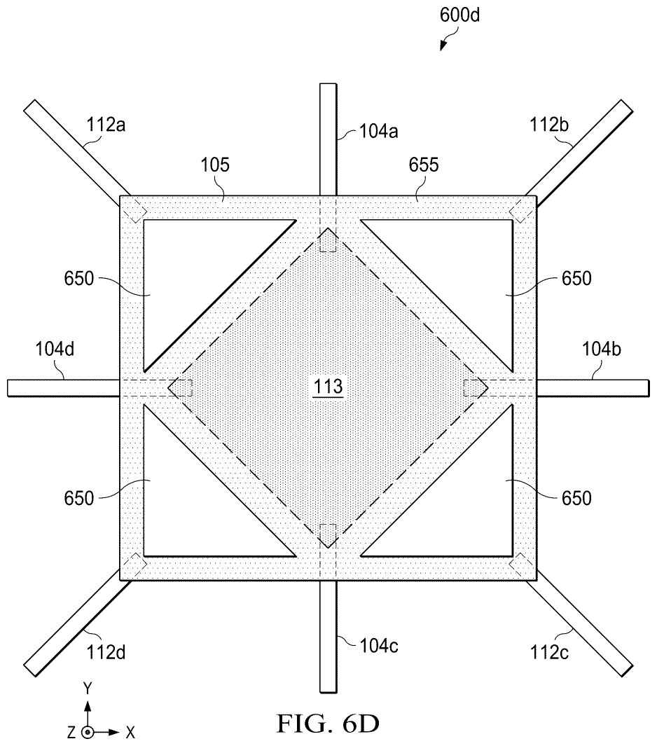

FIG. 6A is a plan view of another sensing system 600a, according to some examples. In sensing system 100 (see FIG. 4A), thermal absorption layer 105 has a rectangular or square shape, with hot junctions of crosstalk sensors 112 being at four corners of thermal absorption layer 105. In contrast, the shape of thermal absorption layer 105 in sensing system 600a of FIG. 6A is different. For example, thermal absorption layer 105 in sensing system 600a has a central portion 615 having a rectangular or square (or a diamond or rhombus) shape, with extension portions 601a, 601b, 601c, and 601d protruding outward from corresponding sides of the central portion 615.

Reflector layers 108a, 108b, 108c, and 108d are at least in part above extension portions 601a, 601b, 601c, and 601d, and hot junctions 420a, 420b, 420c, and 420d of the crosstalk sensors are below extension portions 601a, 601b, 601c, and 601d, respectively. In an example, a length of each of extension portions 601a, 601b, 601c, and 601d may be tuned to calibrate a thermal separation between a footprint of heat spreading layer 113 and a footprint of reflector layers 108a, 108b, 108c, and 108d. The tuning is performed such that crosstalk sensors 112a, 112b, 112c, and 112d are not affected by target IR signals 102). As described above, hot junctions 410a, 410b, 410c, and 410d of the primary sensors may be thermally coupled together by heat spreading layer 113 in proximity to these hot junctions, while hot junctions 420a, 420b, 420c, and 420d of the crosstalk sensors may be thermally coupled together by a thermal conductor in proximity to these hot junctions (not shown in FIG. 6A).

FIGS. 6B, 6C, and 6D are plan views of sensing systems 600b, 600c, and 600d, respectively, according to some examples. In sensing system 100, each of thermal absorption layer 105 and heat spreading layer 113 has a rectangular or square shape (see, e.g., FIG. 4A), with crosstalk sensors 112 being at four corners of thermal absorption layer 105. In contrast, shapes of thermal absorption layer 105 and/or heat spreading layer 113 in sensing systems 600b, 600c, and 600d of FIGS. 6B, 6C, and 6D are different, compared to corresponding shapes in sensing system 100.

Note that for purposes of illustrative clarity, hot junctions and cold junctions of various sensors are not separately labelled in FIGS. 6B, 6C, and 6D. Furthermore, although sections of various sensors may be under thermal absorption layer 105 and/or heat spreading layer 113, such sections are not illustrated using dotted lines in FIGS. 6B, 6C, and 6D (such portions are illustrated using dotted lines in FIGS. 4A and 6A). Also, reflector layers 108 above hot junctions of various crosstalk sensors 112 are not illustrated in FIGS. 6B, 6C, and 6D. Thus, FIGS. 6B, 6C, and 6D convey shapes of thermal absorption layer 105 and heat spreading layer 113.

Referring now to FIG. 6B, thermal absorption layer 105 has an octagonal shape, although other shapes of the thermal absorption layer 105 may also be possible.

Referring now to FIG. 6C, heat spreading layer 113 has a four-pointed star-like or flower petal-like shape generated by concaving sides of a diamond or a rotated square (or a rhombus). Heat spreading layer 113 has four vertices pointing outward in the cardinal directions under which hot junctions of primary sensors 104a, 104b, 104c, and 104d, respectively, are located. Hot junctions of crosstalk sensors 112a, 112b, 112c, and 112d, respectively, are located near four corners of a rectangular or square shaped thermal absorption layer 105. Concaving of the sides of heat spreading layer 113 may increase lateral separation between a footprint of heat spreading layer 113 and hot junctions of crosstalk sensors 112a, . . . , 112d (e.g., such that crosstalk sensors 112a, . . . , 112d are not affected, or are less affected, by IR signals 102).

Referring now to FIG. 6D, heat spreading layer 113 and thermal absorption layer 105 in sensing system 600d have outer peripheries that are similar, at least in part, to outer peripheries of these components in sensing system 100 of FIG. 4A. However, thermal absorption layer 105 in sensing system 600d has a square (or rectangular) shape, with a respective right-angled triangular cutout region 650 at each corner. Cutout regions 650 are oriented so that their right angles are proximal to the corners of the outer periphery of thermal absorption layer 105. In an example, cutout regions 650 prevent or at least reduce heat transfer from heat spreading layer 113 to four corners of thermal absorption layer 105 where the hot junctions of the crosstalk sensors may be located. Thus, hot junctions of crosstalk sensors 112a, . . . , 112d are not affected (or are less affected) by target IR signals 102 that may be absorbed by the center region of thermal absorption layer 105. In some examples, a thermal conduction path may be formed at regions 655 (e.g., the outer ring) of thermal absorption layer 105 to thermally couple regions of the hot junctions of the crosstalk sensors together, such that heat may be more evenly spread to the hot junctions of the crosstalk sensors in a manner similar to the way that heat is spread by heat spreading layer 113 to hot junctions of primary sensors 104a, 104b, 104c, and 104d. In one example, the thermal conduction path between the hot junctions of the crosstalk sensors may include a metal ring (or metal stripes or traces) formed on top of regions 655 of thermal absorption layer 105, where the metal ring (or metal stripes or traces) may also function as reflective layers 108 for the crosstalk sensors. In another example, the thermal conduction path between the hot junctions of the crosstalk sensors may additionally or alternatively include a metal ring (or metal stripes or traces) formed within regions 655 of thermal absorption layer 105 such that the thermal conduction path may be in close proximity to the hot junctions of the crosstalk sensors.

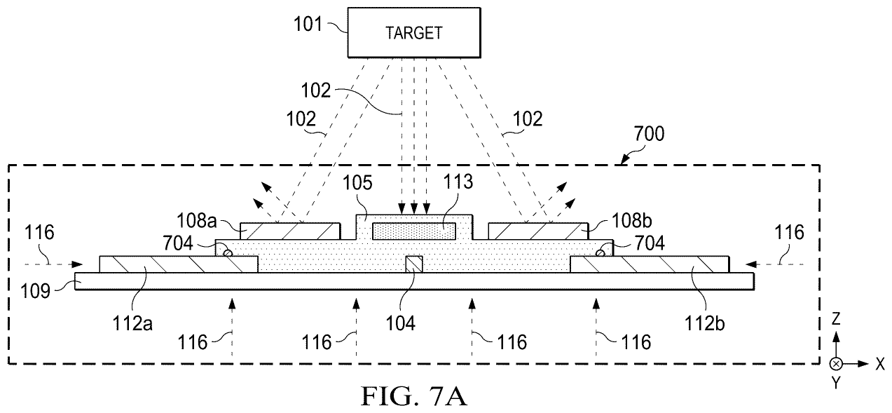

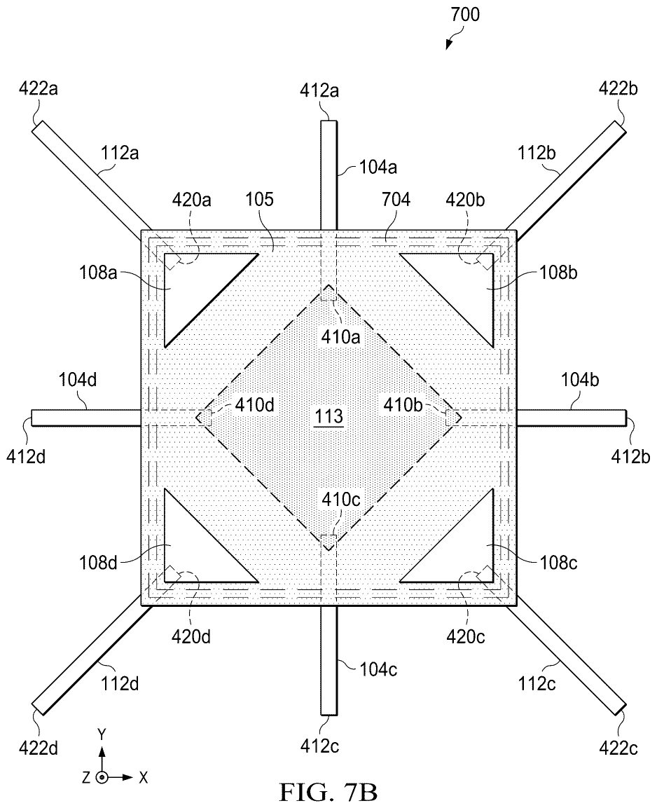

FIGS. 7A and 7B illustrate another sensing system 700, according to some examples. FIG. 7A is a cross-sectional view of sensing system 700, whereas FIG. 7B is a plan view of sensing system 700.

In sensing system 700, heat spreading layer 113 may more efficiently and more evenly dissipate heat to hot junctions 410a, 410b, 410c, and 410d of primary sensors 104a, 104b, 104c, and 104d, respectively, to at least in part maintain similar or uniform temperature distribution across primary sensors 104a, 104b, 104c, and 104d. Similarly, hot junctions 420a, 420b, 420c, and 420d of crosstalk sensors 112a, . . . , 112d, respectively, are thermally coupled by at least a thermally conductive layer 704, such that heat may be more efficiently and more evenly spread to the hot junctions of the crosstalk sensors. For example, the cross-sectional view of FIG. 7A illustrates an example position of thermally conductive layer 704, which is illustrated to be in close proximity to (such as in thermal and/or physical contact with) hot junctions of crosstalk sensors 112a and 112b. In the plan view of FIG. 7B, thermally conductive layer 704 is illustrated using dotted lines, as thermally conductive layer 704 may not be visible in the plan view (e.g., covered by reflector layers 108 and/or thermal absorption layer 105). In an example, thermally conductive layer 704 at least in part thermally couples regions of hot junctions 420a, 420b, 420c, and 420d of crosstalk sensors 112a, . . . , 112d, and at least in part facilitates in achieving similar or uniform temperature distribution across crosstalk sensors 112a, . . . , 112d. The thermally conductive layer 704 comprises thermally conductive material (such as metal or metal alloy). In an example, thermally conductive layer 704 is in close proximity (such as in thermal contact) with one or more (such as all) of the hot junctions 420a, 420b, 420c, and 420d of crosstalk sensors 112a, . . . , 112d. In an example, thermally conductive layer 704 may be in contact with the hot junctions, or may be separated from the hot junctions by at least a portion of thermal absorption layer 105.

Note that although thermally conductive layer 704 is illustrated for the example of FIGS. 7A and 7B, thermally conductive layer 704 may be used in any of the other sensing systems described herein.

In an example, thermally conductive layer 704 may include a thermally conductive material, such as metal. In an example, thermally conductive layer 704 may be a metal line (e.g., a metal trace) that thermally couples hot junctions 420a, 420b, 420c, and 420d of crosstalk sensors 112a, . . . , 112d, respectively. Thermally conductive layer 704 may have a hollow square or rectangular shape, formed in a closed loop shape.

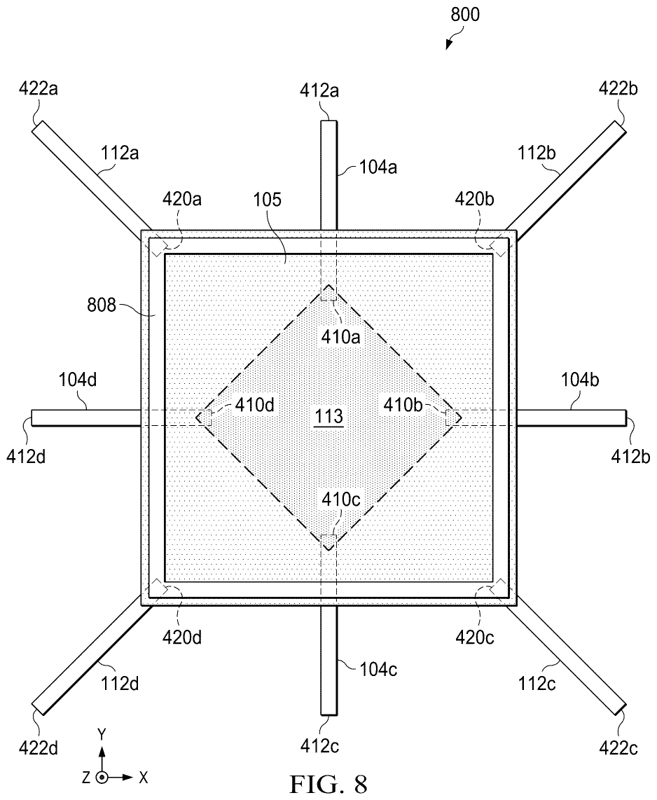

FIG. 8 is a plan view of another sensing system 800, according to some examples. In sensing system 800, various reflector layers 108a, 108b, 108c, and 108d are combined in a single continuous reflector layer 808. Single continuous reflector layer 808 has the shape of a hollow square or rectangle. In an example, single continuous reflector layer 808 is above hot junctions 420a, 420b, 420c, and 420d of each of crosstalk sensors 112a, . . . , 112d, respectively. For example, a footprint of reflector layer 808 at least in part overlaps with hot junctions 420a, 420b, 420c, and 420d of each of crosstalk sensors 112a, . . . , 112d, respectively. In at least one example, sections of each of primary sensors 104a, . . . , 104d passes underneath reflector layer 808.

Note that although reflector layer 808 is shown as a single continuous reflector layer, in another example, reflector layer 808 may include two (or three) discontinuous reflector sections. For example, a first reflector section may be above hot junctions of crosstalk sensors 112a and 112b, and a second reflector section may be above hot junctions of crosstalk sensors 112c and 112d. As described above, in some examples, reflector layer 808 may also function as at least a portion of a thermal conductor that thermally couples the hot junctions of the crosstalk sensors together.

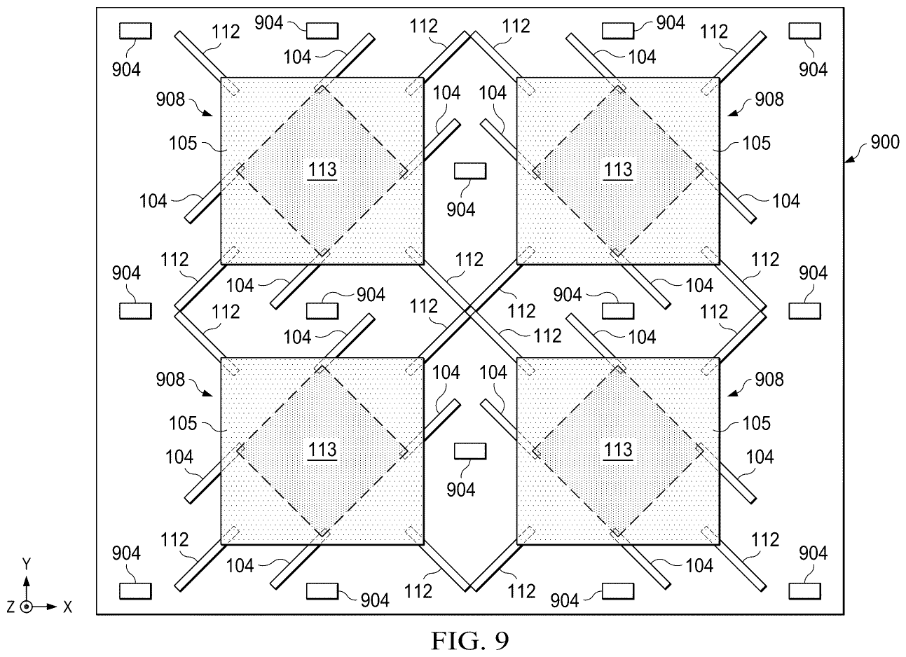

FIG. 9 is a plan view of a sensing system 900 including an array of thermal sensors 908, according to some examples. Sensing system 900 includes a plurality of thermal sensors 908, of which a few are labelled. In an example, each thermal sensor 908 comprises heat spreading layer 113, thermal absorption layer 105, a plurality of primary sensors 104, a plurality of crosstalk sensors 112, and a plurality of reflector layers (e.g., reflective layers 108, not illustrated in FIG. 9 for purposes of illustrative clarity). Although the array of thermal sensors 908 in the illustrated example has a specific shape and/or a specific arrangement of thermal sensors 908, in another example, thermal sensors 908 within the array may be arranged in a different geometric configuration.

In an example, sensing system 900 comprises, in addition to primary sensors 104 and crosstalk sensors 112, a plurality of reference sensors 904 located at various regions of sensing system 900. Reference sensors 904 may be shielded and may not be affected by IR signals 102 or IR signals 116. In an example, reference sensors 904 are configured to measure the temperature of the ambient environment and/or of various sections of sensing system 900, which may further facilitate in estimating temperature of one or more target objects. In an example, sensing system 900 may be used to measure the temperature of a single target 101. In another example, sensing system 900 may be used to measure the temperature of a plurality of target objects.

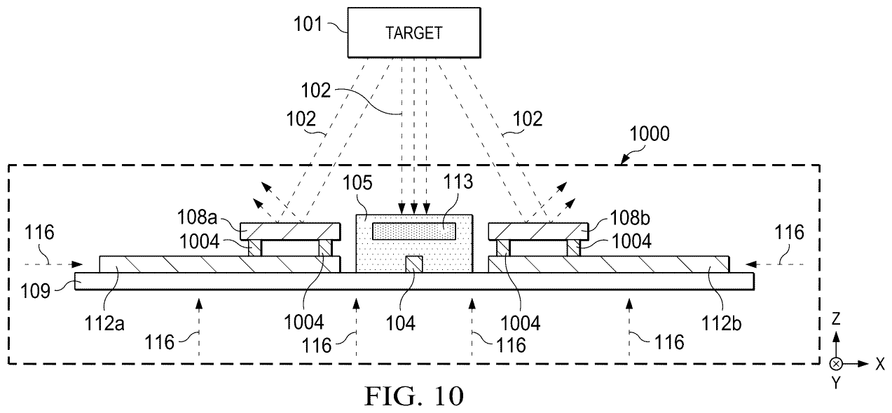

FIG. 10 is a cross-sectional view of another sensing system 1000, according to some examples. In sensing system 100 of FIG. 1, thermal absorption layer 105 is above (at least partially) crosstalk sensors 112 and under reflector layers 108, such that thermal absorption layer 105 is between a crosstalk sensor 112 and a reflector layer 108. In contrast, in sensing system 1000 of FIG. 10, thermal absorption layer 105 may be absent between crosstalk sensor 112 and reflector layer 108. In such an example, each reflector layer 108 may be above a corresponding crosstalk sensor 112 and separated from crosstalk sensor 112 by one or more spacers 1004.

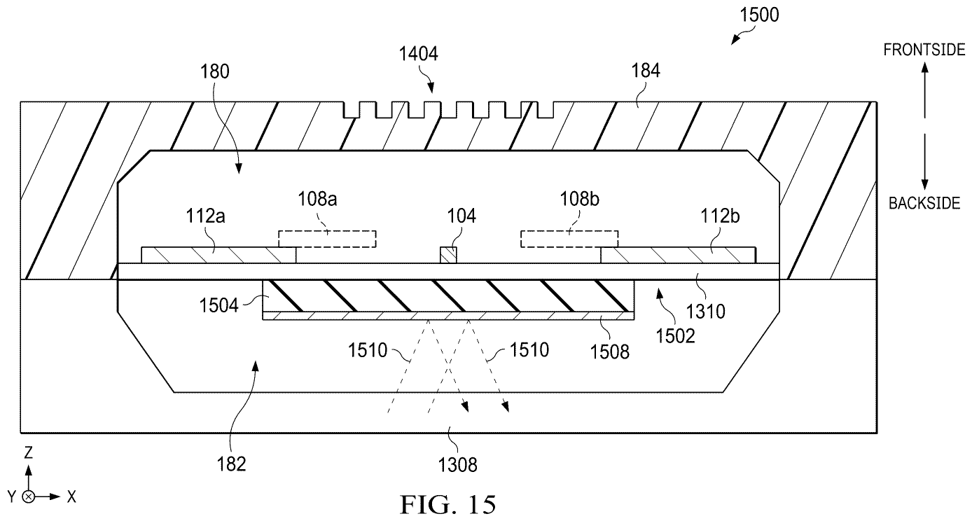

In another example, reflector layers 108 may be on the surface of crosstalk sensors 112 (e.g., see FIG. 15). For example, the bottom surface of reflector layer 108a may be on a top surface of crosstalk sensor 112a. In such an example, spacer 1004 and/or thermal absorption layer 105 may be absent between reflector layer 108 and crosstalk sensor 112.

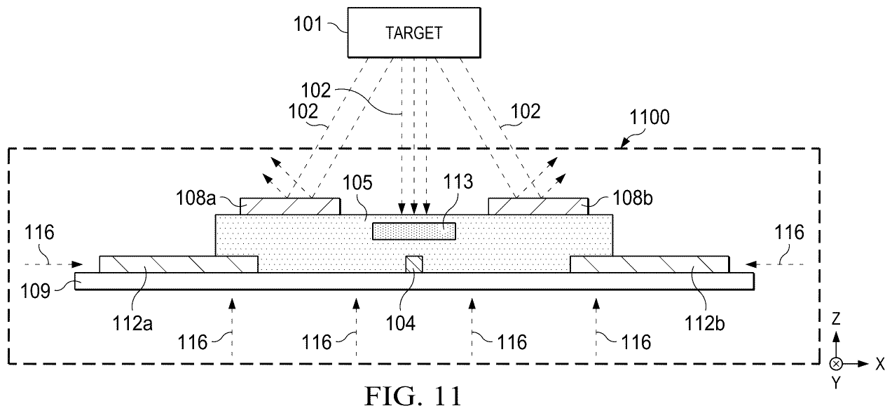

FIG. 11 is a cross-sectional view of yet another sensing system 1100, according to some examples. In sensing system 100 of FIG. 1, the top surfaces of a first section of thermal absorption layer 105 above primary sensor 104 and a second section of thermal absorption layer 105 above crosstalk sensors 112 are at different heights (e.g., top surfaces of the first section and the second section are not coplanar). However, in FIG. 11, the top surfaces of the first section of thermal absorption layer 105 above primary sensor 104 and the second section of thermal absorption layer 105 above crosstalk sensors 112 are coplanar. In another example, the top surface of the first section of thermal absorption layer 105 above primary sensor 104 and the top surface of the second section of thermal absorption layer 105 above crosstalk sensors 112 may be at any appropriate heights and may be formed independent of each other.

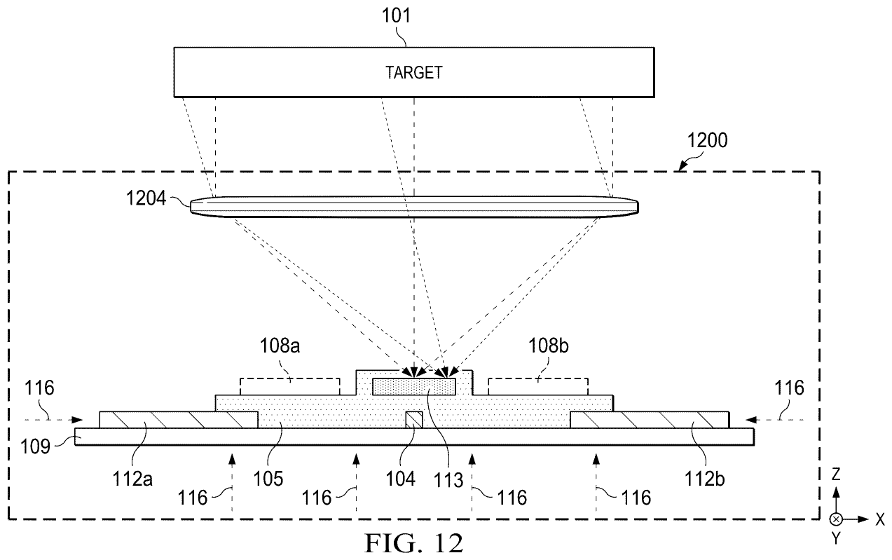

FIG. 12 is a cross-sectional view of yet another sensing system 1200, according to some examples. In sensing system 100 of FIG. 1, reflector layers 108 facilitate in shielding crosstalk sensors 112 from receiving target IR signals 102. In contrast, in sensing system 1200 of FIG. 12, instead of (or in addition to) reflector layers 108, a lens 1204 may focus IR signals 102 from target 101 towards a center region of thermal absorption layer 105 and away from the regions where crosstalk sensors 112 are located. For example, the configuration and/or placement of lens 1204 may be such that IR signals 102 passing through lens 1204 are directed towards the center region of thermal absorption layer 105 and away from the regions where crosstalk sensors 112 are located.

In an example, in sensing system 1200, reflector layers 108 may be absent, as lens 1204 acts as a shield, to prevent or at least reduce chances of IR signals 102 from reaching the regions where crosstalk sensors 112 are located. In another example, in sensing system 1200, reflector layers 108 may also be present, in addition to lens 1204 (e.g., to further shield crosstalk sensors 112 from IR light 102). Accordingly, reflector layers 108 are illustrated in dotted lines in FIG. 12.

In various examples, lens 1204 includes at least one of a refractive optical element, a diffractive optical element, a metasurface optical element, a gradient-index (GRIN) optical element, a graded index optical element, a Fresnel optical element, or a Fresnel zone plate. In various examples, lens 1204 includes at least one of a refractive lens, a diffractive lens, or a metalens. The refractive lens may include, for example, a convex lens, a double convex lens, a plano-convex lens, a converging meniscus lens, or one or more groups of lenses. The diffractive lens may include, for example, a Fresnel lens, a Fresnel zone plate, a holographic lens, or a surface-relief grating based lens. In some examples, lens 1204 may include an array of lenses, such as an array of geometric microlenses, an array of metalenses, an array of Fresnel lenses, and the like. In another example, lens 1204 may be replaced by a diffractive optical element (e.g., grating) or a prism, e.g., to direct IR signals 102 towards the area of thermal absorption layer 105 in contact with heat spreading layer 113 and away from crosstalk sensors 112. Lens 1024 may be fabricated on various materials that have low absorption (e.g., transparent) for IR light (e.g., MWIR or LWIR light). In some examples, lens 1024 may be part of an enclosure of the sensing system. For example, lens 1024 may be fabricated in a cover plate of the sensing system, or may be fabricated on another material layer and then bonded to the cover plate or positioned in an aperture of the cover plate. In some examples, lens 1024 may include an active lens or shutter (e.g., including an electro-optic (EO) material) that may be switched on or off electrically.

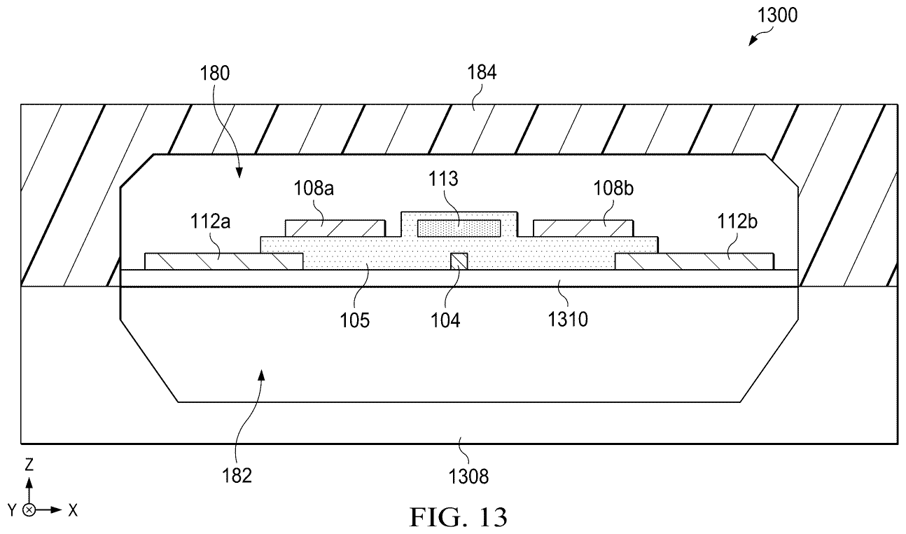

FIG. 13 is a cross-sectional view of a packaged device 1300 comprising a sensing system (e.g., sensing system 100), according to some examples. In device 1300, sensing system 100 is positioned within a cavity 180 formed by an enclosure 184 and a die 1308, which, in combination, enclose the various sensors of sensing system 100. For example, die 1308 forms a lower portion of device 1300, and enclosure 184 forms an upper portion of device 1300. In an example, cavity 180 is above reflector layers 108 and thermal absorption layer 105, and a cavity 182 is below primary sensor 104, crosstalk sensors 112, and thermal absorption layer 105. Cavities 180 and 182 maybe vacuum or maybe gas filled (e.g., with are or an inert gas). In an example, cavities 180 and 182 act as thermal insulation, e.g., to prevent or at least reduce heat transfer between sensing system 100 and enclosure 184 or lower portion of die 1308. In an example, die 1308 defines lower cavity 182 (e.g., cavity 182 is formed within die 1308), and enclosure 184 defines upper cavity 180 (e.g., cavity 180 is within enclosure 184). In an example, device 1300 includes a support structure 1310 mechanically supporting primary sensors 104, crosstalk sensors 112, and thermal absorption layer 105. In some examples, support structure 1310 may be die 109 or a substrate of sensing system 100.

In an example, enclosure 184 comprises a material that is transparent to IR signals 102 (e.g., allows passage of target IR signals 102 through enclosure 184 to reflector layers 108 and thermal absorption layer 105). In an example, enclosure 184 comprises silicon, although other materials that are transparent to IR signals may be used. As described above, in some examples, a lens or another optical component may be formed on or in enclosure 184 to direct the incident IR signals 102 towards a center region of thermal absorption layer 105. The optical component can be formed on an outer surface and/or inner surface of enclosure 184.

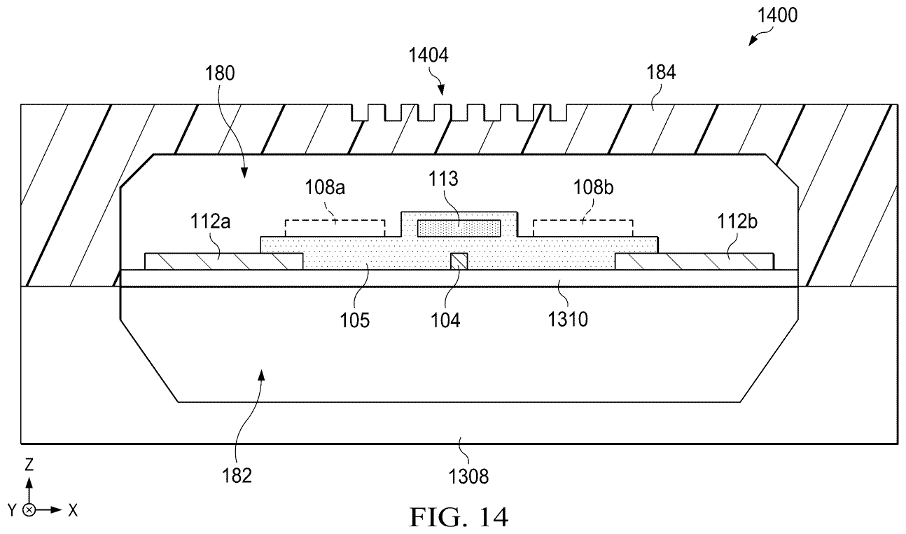

FIG. 14 is a cross-sectional view of a packaged device 1400 comprising a sensing system (e.g., sensing system 100), according to some examples. Device 1400 comprises an optical structure embedded within or formed on one or more surfaces (e.g., outer and/or inner surfaces) of enclosure 184. For example, enclosure 184 may include an aperture (or window) and a lens 1404 at the aperture (or window). In an example, lens 1404 is configured to direct IR signals 102 from target 101 towards the area of thermal absorption layer 105 in contact with heat spreading layer 113, and away from crosstalk sensors 112. For reasons described above with respect to, for example, FIG. 12, in the sensing system of FIG. 14, reflector layers 108 may optionally be absent (or present).

In an example, lens 1404 includes at least one of a refractive lens, a diffractive lens, or a metalens. The refractive lens may include, for example, a convex lens, a double convex lens, a plano-convex lens, a converging meniscus lens, or one or more groups of lenses. The diffractive lens may include, for example, a Fresnel lens, a Fresnel zone plate, a holographic lens, or a surface-relief grating based lens. In some examples, lens 1404 may include an array of lenses, such as an array of microlenses, an array of metalenses, an array of Fresnel lenses, and the like. In an example, instead of lens 1404, packaged device 1400 may include a diffractive optical element (e.g., a grating) or a prism, e.g., to direct IR signals 102 towards the area of thermal absorption layer 105 in contact with heat spreading layer 113 and away from crosstalk sensors 112.

FIG. 15 is a cross-sectional view of a packaged device 1500 comprising a sensing system 1502, according to some examples. Sensing system 1502 includes a backside reflector layer 1508. In an example, backside reflector layer 1508 is below or on a backside of primary sensors 104 and crosstalk sensors 112. For example, primary sensor 104 receives IR signals 102 from a first side (e.g., a top or front side in FIG. 15), and backside reflector layer 1508 is on an opposing second side of primary sensor 104. In an example, backside reflector layer 1508 reflects any crosstalk IR signal that may be incident on packaged device 1500 from the backside. Example IR signals 1510 are illustrated in FIG. 15, where IR signals 1510 are reflected by backside reflector layer 1508, such that IR signals 1510 may not reach or otherwise affect primary sensor 104 and/or crosstalk sensors 112. Example material for backside reflector layer 1508 may include a thermally reflective material, such as a metal (e.g., similar to reflector layers 108 described above).

In an example, backside reflector layer 1508 may be attached to the backside of primary sensor 104 and/or crosstalk sensors 112 either directly or through an intervening layer 1504. Intervening layer 1504 may comprise a thermal absorption material, or another material.

FIG. 15 also illustrates sensing system 1502 without thermal absorption layer 105 and heat spreading layer 113. In this example, primary sensor 104 may be directly exposed to the target IR signals without an intervening thermal absorption layer 105 and/or heat spreading layer 113. Furthermore, due to the presence of lens 1404, reflector layers 108 above crosstalk sensors 112 may also be optional (hence, illustrated using dotted lines). For example, primary sensor 104 and/or crosstalk sensors 112 may be sensors that can absorb and convert IR light into electrical signals, such as IR photodetectors including IR photodiodes, rather than thermocouples or thermopiles. Note that the lack of thermal absorption layer 105 and heat spreading layer 113, as illustrated in FIG. 15, may also be applicable to any of the sensing systems described herein when primary sensor 104 and/or crosstalk sensors 112 can absorb and convert IR light into electrical signals, such as IR photodetectors (e.g., IR photodiodes).

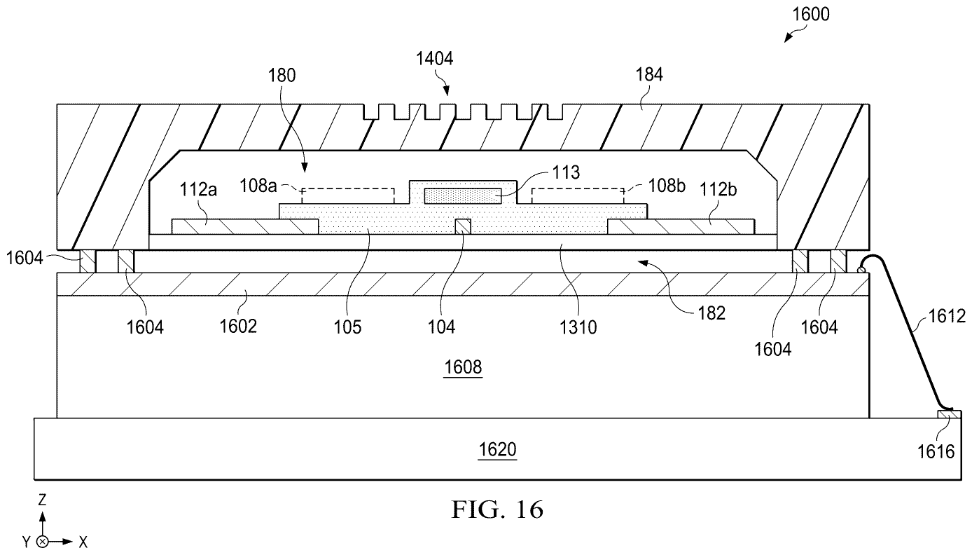

FIG. 16 is a cross-sectional view of a packaged device 1600 comprising a sensing system (e.g., sensing system 100), according to some examples. In device 1600, primary sensors 104, crosstalk sensors 112, thermal absorption layer 105, and/or heat spreading layer 113 of sensing system 100 may be separated from a die 1608 by a cavity 182, which acts as a thermal insulator (e.g., see discussion above with respect to FIG. 13). Die 1608 may include one or more metallization layers 1602 (symbolically illustrated in FIG. 16 using a box) that comprises a plurality of interconnection structures (such as metal traces) for electrical coupling between various components. Metallization layers 1602 may be electrically coupled to sensors 104 and 112 using structures 1604. In an example, one or more structures 1604 may be conductive interconnection structures for electrical connection between sensors 104 and 112 and metallization layers 1602. In an example, another one or more structures 1604 may be non-conductive structures to support components of sensing system 100 above cavity 182.

In an example, structures 1604 may be opaque to IR light and may, in combination with metallization layers 1602, form at least a partial shield structure to block transmission of unwanted IR signals in horizontal direction or from the backside of device 1600 through cavity 182 to one or more of sensors 104 and 112.

In an example, die 1608 may be on a substrate, such as a printed circuit board (PCB) 1620. A plurality of bonding wires 1612 may be used to electrically couple metallization layers 1602 to PCB 1620 (e.g., through corresponding bond pads 1616).

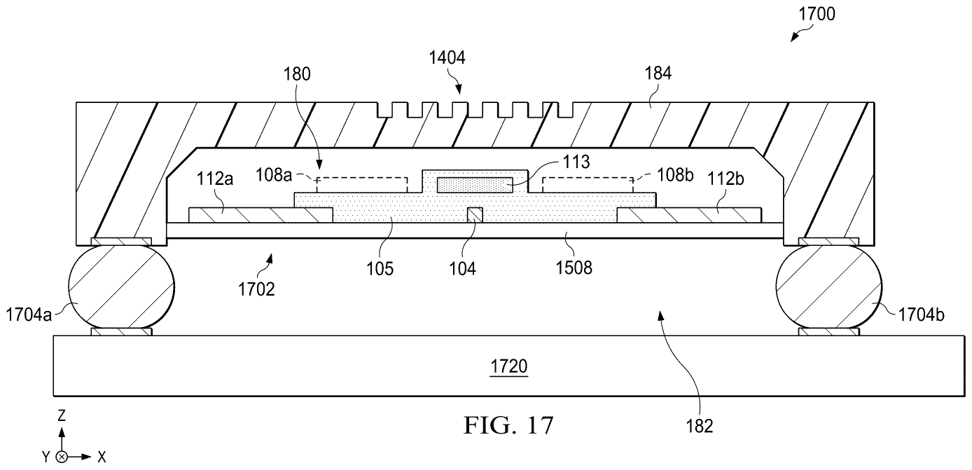

FIG. 17 is a cross-sectional view of a packaged device 1700 comprising a sensing system 1702, according to some examples. In the illustrated example, sensing system 1702 includes a backside reflector layer 1508 on the backside of primary sensors 104 and crosstalk sensors 112, e.g., as described above with respect to FIG. 15. Sensing system 1702 may be electrically coupled to a substrate 1720 (such as a PCB or a semiconductor die) through a plurality of solder balls (such as solder balls 1704a and 1704b illustrated in the figure). In an example, solder balls 1704a and 1704b generate a clearance between backside reflector layer 1508 and substrate 1720, thereby forming cavity 182 therebetween. In an example, cavity 182 acts as a thermal insulator, as described above.

Following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementations without changing the scope of disclosure.
Example 1. An apparatus comprising: a thermal absorption layer; a first thermal sensor including at least a first portion in the thermal absorption layer; a second thermal sensor including at least a second portion in the thermal absorption layer; a heat spreading layer in contact with an area of the thermal absorption layer, wherein a first lateral distance between the heat spreading layer and the first portion of the first thermal sensor is less than a second lateral distance between the heat spreading layer and the second portion of the second thermal sensor; and a structure on or above a surface of the thermal absorption layer and configured to prevent thermal signals emitted by a target heat source from reaching the second thermal sensor.
Example 2. The apparatus of example 1, wherein the thermal absorption layer includes an oxide, a polymer, or a doped semiconductor material.
Example 3. The apparatus of any one of examples 1-2, wherein the heat spreading layer is at least partially embedded in the thermal absorption layer.
Example 4. The apparatus of any one of examples 1-4, wherein the heat spreading layer at least partially overlaps with the first thermal sensor and has no overlap with the second thermal sensor.
Example 5. The apparatus of any one of examples 1-4, wherein the heat spreading layer includes a metal layer configured to reflect infrared light.
Example 6. The apparatus of any one of examples 1-5, wherein the first thermal sensor includes a plurality of thermal sensing elements, wherein each thermal sensing element of the plurality of thermal sensing elements includes a portion adjacent to or partially overlapping with the heat spreading layer.
Example 7. The apparatus of example 6, wherein the plurality of thermal sensing elements includes a plurality of infrared photodetectors, or a plurality of thermocouples coupled together to form a thermopile.
Example 8. The apparatus of any one of examples 6-7, wherein: the heat spreading layer has a plurality of vertices; and each thermal sensing element of the plurality of thermal sensing elements includes: a first thermal sensing junction adjacent to or partially overlapping with a respective vertex of the plurality of vertices of the heat spreading layer; and a second thermal sensing junction outside of the thermal absorption layer and coupled to a thermal ground.
Example 9. The apparatus of any one of examples 1-8, wherein the first portion of the first thermal sensor is in a layer above or below the heat spreading layer in the thermal absorption layer.
Example 10. The apparatus of any one of examples 1-9, wherein the first portion of the first thermal sensor and the second portion of the second thermal sensor are on a same layer or different layers in the thermal absorption layer.
Example 11. The apparatus of any one of examples 1-10, wherein: the second thermal sensor includes a plurality of thermal sensing elements; each thermal sensing element of the plurality of thermal sensing elements includes a portion in a respective peripheral region of a plurality of peripheral regions of the thermal absorption layer; and a lateral distance between the heat spreading layer and the portion of each thermal sensing element of the plurality of thermal sensing elements is greater than a threshold value.
Example 12. The apparatus of example 11, wherein: the plurality of thermal sensing elements includes a plurality of thermocouples or a plurality of infrared photodetectors; and the portion of each thermal sensing element of the plurality of thermal sensing elements includes a thermal sensing junction.
Example 13. The apparatus of example 12, further comprising: a thermally conductive path that thermally couples a first thermal sensing junction of a first thermocouple of the plurality of thermocouples to a second thermal sensing junction of a second thermocouple of the plurality of thermocouples.
Example 14. The apparatus of any one of examples 11-13, wherein the structure includes a metal layer above or on the surface of the thermal absorption layer, the metal layer overlapping with at least the portion of each thermal sensing element of the plurality of thermal sensing elements.
Example 15. The apparatus of any one of examples 1-14, wherein the structure includes a lens above the thermal absorption layer, or a heat reflective metal layer above or on the surface of the thermal absorption layer.
Example 16. The apparatus of any one of examples 1-15, further comprising one or more lenses configured to direct the thermal signals emitted by the target heat source towards the area of the thermal absorption layer in contact with the heat spreading layer and away from the second thermal sensor.
Example 17. The apparatus of example 16, wherein the one or more lenses include at least one of a refractive optical element, a diffractive optical element, a metasurface optical element, a gradient-index (GRIN) optical element, a Fresnel optical element, or a Fresnel zone plate.
Example 18. The apparatus of any one of examples 1-17, further comprising an enclosure that encloses the first and second thermal sensors and forms a cavity above the heat spreading layer, wherein at least a region of the structure is exposed to the cavity.
Example 19. The apparatus of example 18, wherein the enclosure includes an aperture and a lens at the aperture, the lens configured to direct the thermal signals emitted by the target heat source towards the area of the thermal absorption layer in contact with the heat spreading layer and away from the second thermal sensor.
Example 20. The apparatus of any one of examples 18-19, further comprising a third thermal sensor in the enclosure and separate from the thermal absorption layer.
Example 21. The apparatus of any one of examples 1-20, further comprising a processing circuit electrically coupled to the first thermal sensor and the second thermal sensor, the processing circuit configured to determine a temperature of the target heat source based on outputs of the first thermal sensor and the second thermal sensor.
Example 22. A device comprising: an enclosure; a semiconductor die; and a sensing system enclosed by the enclosure and the semiconductor die and electrically coupled to the semiconductor die, the sensing system comprising: a thermal absorption layer; a primary thermal sensor and a crosstalk thermal sensor, wherein at least a section of each of the primary thermal sensor and the crosstalk thermal sensor is in the thermal absorption layer; a first metal layer at least in part embedded within the thermal absorption layer, the first metal layer at least in part overlapping with the primary thermal sensor; and a second metal layer above the thermal absorption layer, the second metal layer at least in part overlapping with the crosstalk thermal sensor.
Example 23. The device of example 22, wherein the semiconductor die comprises: a processing circuit electrically coupled to the primary thermal sensor and the crosstalk thermal sensor, the processing circuit configured to determine a temperature of a target heat source based on outputs of the primary thermal sensor and the crosstalk thermal sensor.
Example 24. The device of any one of examples 22-23, wherein: the enclosure and the sensing system define a first cavity; the semiconductor die and the sensing system define a second cavity; and the sensing system further comprises a reflective layer facing the second cavity.
Example 25. An apparatus comprising: at least one primary thermal sensor and a plurality of crosstalk thermal sensors, wherein each of the plurality of crosstalk thermal sensors comprises a sensing junction; a metal layer in thermal contact with the sensing junction of each of the plurality of crosstalk thermal sensors; and processing circuitry electrically coupled to the at least one primary thermal sensor and the plurality of crosstalk thermal sensors, the processing circuitry configured to: estimate a crosstalk experienced by the primary thermal sensor, based at least in part on outputs of one or more of the plurality of crosstalk thermal sensors; and determine a temperature of a target heat source based on an output of the at least one primary thermal sensor and the estimated crosstalk.
Example 26. The apparatus of example 25, further comprising: a structure configured to prevent thermal signals emitted by the target heat source from reaching the plurality of crosstalk thermal sensors.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics, or semiconductor components.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuit. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be in depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN), or a gallium arsenide substrate (GaAs).

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. An apparatus comprising:
a thermal absorption layer;
a first thermal sensor including at least a first portion in the thermal absorption layer;
a second thermal sensor including at least a second portion in the thermal absorption layer;
a heat spreading layer in contact with an area of the thermal absorption layer, wherein a first lateral distance between the heat spreading layer and the first portion of the first thermal sensor is less than a second lateral distance between the heat spreading layer and the second portion of the second thermal sensor; and
a structure on or above a surface of the thermal absorption layer and configured to prevent thermal signals emitted by a target heat source from reaching the second thermal sensor.

2. The apparatus of claim 1, wherein the thermal absorption layer includes an oxide, a polymer, or a doped semiconductor material.

3. The apparatus of claim 1, wherein the heat spreading layer is at least partially embedded in the thermal absorption layer.

4. The apparatus of claim 1, wherein the heat spreading layer at least partially overlaps with the first thermal sensor and has no overlap with the second thermal sensor.

5. The apparatus of claim 1, wherein the heat spreading layer includes a metal layer configured to reflect infrared light.

6. The apparatus of claim 1, wherein the first thermal sensor includes a plurality of thermal sensing elements, wherein each thermal sensing element of the plurality of thermal sensing elements includes a portion adjacent to or partially overlapping with the heat spreading layer.

7. The apparatus of claim 6, wherein the plurality of thermal sensing elements includes a plurality of infrared photodetectors, or a plurality of thermocouples coupled together to form a thermopile.

8. The apparatus of claim 6, wherein:
the heat spreading layer has a plurality of vertices; and
each thermal sensing element of the plurality of thermal sensing elements includes:
a first thermal sensing junction adjacent to or partially overlapping with a respective vertex of the plurality of vertices of the heat spreading layer; and
a second thermal sensing junction outside of the thermal absorption layer and coupled to a thermal ground.

9. The apparatus of claim 1, wherein the first portion of the first thermal sensor is in a layer above or below the heat spreading layer in the thermal absorption layer.

10. The apparatus of claim 1, wherein the first portion of the first thermal sensor and the second portion of the second thermal sensor are on a same layer or different layers in the thermal absorption layer.

11. The apparatus of claim 1, wherein:
the second thermal sensor includes a plurality of thermal sensing elements;
each thermal sensing element of the plurality of thermal sensing elements includes a portion in a respective peripheral region of a plurality of peripheral regions of the thermal absorption layer; and
a lateral distance between the heat spreading layer and the portion of each thermal sensing element of the plurality of thermal sensing elements is greater than a threshold value.

12. The apparatus of claim 11, wherein:
the plurality of thermal sensing elements includes a plurality of thermocouples or a plurality of infrared photodetectors; and
the portion of each thermal sensing element of the plurality of thermal sensing elements includes a thermal sensing junction.

13. The apparatus of claim 12, further comprising:
a thermally conductive path that thermally couples a first thermal sensing junction of a first thermocouple of the plurality of thermocouples to a second thermal sensing junction of a second thermocouple of the plurality of thermocouples.

14. The apparatus of claim 11, wherein the structure includes a metal layer above or on the surface of the thermal absorption layer, the metal layer overlapping with at least the portion of each thermal sensing element of the plurality of thermal sensing elements.

15. The apparatus of claim 1, wherein the structure includes a lens above the thermal absorption layer, or a heat reflective metal layer above or on the surface of the thermal absorption layer.

16. The apparatus of claim 1, further comprising one or more lenses configured to direct the thermal signals emitted by the target heat source towards the area of the thermal absorption layer in contact with the heat spreading layer and away from the second thermal sensor.

17. The apparatus of claim 16, wherein the one or more lenses include at least one of a refractive optical element, a diffractive optical element, a metasurface optical element, a gradient-index (GRIN) optical element, a Fresnel optical element, or a Fresnel zone plate.

18. The apparatus of claim 1, further comprising an enclosure that encloses the first and second thermal sensors and forms a cavity above the heat spreading layer, wherein at least a region of the structure is exposed to the cavity.

19. The apparatus of claim 18, wherein the enclosure includes an aperture and a lens at the aperture, the lens configured to direct the thermal signals emitted by the target heat source towards the area of the thermal absorption layer in contact with the heat spreading layer and away from the second thermal sensor.

20. The apparatus of claim 18, further comprising a third thermal sensor in the enclosure and separate from the thermal absorption layer.

21. The apparatus of claim 1, further comprising a processing circuit electrically coupled to the first thermal sensor and the second thermal sensor, the processing circuit configured to determine a temperature of the target heat source based on outputs of the first thermal sensor and the second thermal sensor.

22. A device comprising:
an enclosure;
a semiconductor die; and
a sensing system enclosed by the enclosure and the semiconductor die and electrically coupled to the semiconductor die, the sensing system comprising:
a thermal absorption layer;
a primary thermal sensor and a crosstalk thermal sensor, wherein at least a section of each of the primary thermal sensor and the crosstalk thermal sensor is in the thermal absorption layer;
a first metal layer at least in part embedded within the thermal absorption layer, the first metal layer at least in part overlapping with the primary thermal sensor; and
a second metal layer above the thermal absorption layer, the second metal layer at least in part overlapping with the crosstalk thermal sensor.

23. The device of claim 22, wherein the semiconductor die comprises:
a processing circuit electrically coupled to the primary thermal sensor and the crosstalk thermal sensor, the processing circuit configured to determine a temperature of a target heat source based on outputs of the primary thermal sensor and the crosstalk thermal sensor.

24. The device of claim 22, wherein:
the enclosure and the sensing system define a first cavity;
the semiconductor die and the sensing system define a second cavity; and
the sensing system further comprises a reflective layer facing the second cavity.

25. An apparatus comprising:
at least one primary thermal sensor and a plurality of crosstalk thermal sensors, wherein each of the plurality of crosstalk thermal sensors comprises a sensing junction;
a metal layer in thermal contact with the sensing junction of each of the plurality of crosstalk thermal sensors; and
processing circuitry electrically coupled to the at least one primary thermal sensor and the plurality of crosstalk thermal sensors, the processing circuitry configured to:
estimate a crosstalk experienced by the primary thermal sensor, based at least in part on outputs of one or more of the plurality of crosstalk thermal sensors; and
determine a temperature of a target heat source based on an output of the at least one primary thermal sensor and the estimated crosstalk.

26. The apparatus of claim 25, further comprising:
a structure configured to prevent thermal signals emitted by the target heat source from reaching the plurality of crosstalk thermal sensors.
